(19) United States
(12) Patent Application Publication
(10) Pub. No.: US 2022/0404777 A1
(43) Pub. Date: Dec. 22, 2022

(54) DESIGN METHOD FOR UNDISTURBED SWITCHING OF LINEAR CONTROLLERS

(71) Applicants: DUT ARTIFICIAL INTELLIGENCE INSTITUTE, DALIAN, Dalian (CN); DALIAN AEROSPACE POWER CONTROL SYSTEM CO., LTD, Dalian (CN)

(72) Inventors: Sixin WEN, Dalian (CN); Ximing SUN, Dalian (CN); Yanhua MA, Dalian (CN); Xian DU, Dalian (CN); Jingwen DU, Dalian (CN); Zhuorui PAN, Dalian (CN); Guangchao HAO, Dalian (CN); Yuwen HAO, Dalian (CN)

(73) Assignees: DUT ARTIFICIAL INTELLIGENCE INSTITUTE, DALIAN, Dalian (CN); DALIAN AEROSPACE POWER CONTROL SYSTEM CO., LTD, Dalian (CN)

(21) Appl. No.: 17/777,015

(22) PCT Filed: Oct. 30, 2020
(86) PCT No.: PCT/CN2020/125570

§ 371 Date: May 13, 2022

(30) Foreign Application Priority Data
Sep. 29, 2020 (CN) 202011051685.4

(51) Int. Cl. G05B 7/02; G05B 11/32

(52) U.S. Cl. CPC G05B 7/02; G05B 11/32

(57) ABSTRACT

A design method for undisturbed switching of linear controllers is provided for solving the problem of sudden system response change or an unstable control circuit caused by switching of multiple linear controllers, in which the linear controllers include proportional-integral-derivative (PID), linear-quadratic-Gaussian (LQG), linear active disturbance rejection control (LADRC), H∞, model reference adaptive control (MRAC), and open-loop controllers. Firstly, differentials tbr outputs of the controllers are found, then through controller decision, a controller is selected to be connected to a closed-loop control circuit, and a differential term of the controller connected to the closed-loop control circuit is integrated through a common integrator, thereby ensuring smooth controller switching. The design method has a simple structure and good versatility, is operable, and can be easily applied to various actual control systems without requiring parameter adjustment.

### CROSS REFERENCE TO THE RELATED APPLICATIONS

This application is the national stage entry of a 371 application PCT/CN2020/125570 filed on Oct. 30, 2020 and is based upon and claims priority to Chinese Patent Application No. 202011051685.4 filed on Sep. 29, 2020, the entire content of which are incorporated herein by reference.

### TECHNICAL FIELD

The present disclosure relates to the technical field of automatic control, and specifically, to a design method for undisturbed switching of linear controllers.

### BACKGROUND

In an actual control system, many plants have characteristics such as strong coupling, nonlineanty, and time variance, causing difficulty in the traditional classical control theory for meeting control performance requirements. Therefore, academia and industry have conducted research on the theory for switching control of multiple sub-controllers, in which the sub-controllers are designed for different working conditions of a system to meet performance indicators, and a specific sub-controller is selected based on a switching signal to enter a closed-loop control system. Switching control of multiple linear controllers is required in many scenarios. In the present disclosure, an aero-engine is used as a typical example for discussion. Requirements of an aero-engine switching control system specifically include: mode switching, multi-loop switching, multi-target switching, and. multi-point switching, fault-tolerant control switching, saturation switching, and the like. However, the switching between multiple sub-controllers is prone to discontinuous control quantities, and the system response is likely to change suddenly or unstable control may occur.

Considering that most of existing industrial control systems use linear controllers, such as proportional-integral-deriyative (PID), linear-quadratic-Gaussian (LQG), linear active disturbance rejection control (LADRC), H∞, and model reference adaptive control (MRAC) controllers, it is necessary to propose a design method for undisturbed switching of linear controllers, to prevent the control system from being affected by controller switching. The design objectives of the undisturbed switching method for a linear controller are as follows:

(1) When no controller switching occurs, the performance of the control system is determined by a controller that has been connected to a closed-loop circuit; (2) when controller switching occurs, the undisturbed switching design method functions, such that control signals at a switching moment change smoothly without sudden change or instability; (3) the design method is versatile and is suitable for undisturbed switching between a single-variable controller and a multi-variable controller, and between an open-loop controller and a closed-loop controller; and (4) the design method minimizes modifications to an original controller, is operable, and can be applied to various actual control systems with a simple parameter adjustment or without a parameter adjustment.

The existing undisturbed switching design methods use weighting-based transition in a switching process, or design a switching controller according to the switching control theory of average dwell time. These methods pose high requirements on expertise of operators in practical projects, and the operators need to repeatedly adjust parameters. Moreover, these methods are inoperable in many practical projects and have poor application effects. So far, no disclosed design methods can satisfy the above four design objectives at the same time. Therefore, the present disclosure aims to propose an undisturbed switching design method that satisfies the above four design obⱼectives to solve the problem of sudden system change caused by linear controller switching in practical projects. It should be noted that there is often switching from manual control to machine control or switching from an open-loop controller to a closed-loop controller in an actual control system. In the present disclosure, an open-loop controller is treated as a linear controller, so the undisturbed switching design method proposed by the present disclosure is also applicable to switching from an open-loop controller to a closed-loop controller.

### SUMMARY

in order to solve the problem of sudden system response change or even unstable control caused by switching of multiple linear controllers, the present disclosure proposes a design method for undisturbed switching of linear controllers.

To solve the above technical problem, the present disclosure adopts the following solution: A design method for undisturbed switching of linear controllers includes the following steps:

Step 1: Directly establish a numerical simulation program of a control system without considering impact of controller switching.

FIG. 1 shows a control framework of the control system in step 1, in which a plant is a general nonlinear model, which is expressed as:

$$\{ \begin{matrix}\dot{x} = f ( x , u ) \\ y = g ( x , u )\end{matrix}$$

where f is a nonlinear function of system state; g is a nonlinear function of system output; y is an output quantity of the plant; and u is a control quantity output by a switching controller.

Step 2: Without considering impact of controller switching, directly design controllers such that performance of the closed-loop control system meets an expected design requirement.

In step 2, the proposed undisturbed switching design method is for all linear controllers and open-loop controllers, such as PID, LQG, LADRC, and H∞, controllers. The controller in the present disclosure is specifically a switching controller including an open-loop controller, an H∞ controller, and an LADRC controller.

First, in terms of the open-loop controller, the nonlinear model is designed as follows: an open-loop control law is abstracted as an interpolation function interp according to an interpolation table [r_{Table};value_{Table}], and a reference input is set to r, to obtain:

u=interp(r,[r_{Table};value_{Table])}

Second, in terms of the H∞ controller, the nonlinear model is designed as follows: and the nonlinear model is linearized to obtain a linear system:

$$\{ \begin{matrix}\dot{x} = Ax + Bu \\ y = Cx + Du\end{matrix}$$

FIG. 2 is a schematic diagram of a closed-loop control system based on H∞. If r, e, u and y represent a reference input, a tracking error, a control input, and a system output, respectively, C(s) represents an H∞ controller, and G(s) represents a controlled-object model, closed-loop transfer functions from r to e, u, and y separately may be obtained:

$$\{ \begin{matrix}\begin{matrix}S ( s ) = \frac{e ( s )}{r ( s )} = {( I + G ( s ) C ( s ) )}^{- 1} \\ R ( s ) = \frac{u ( s )}{r ( s )} = C ( s ) S ( s ) = C ( s ) {( I + G ( s ) C ( s ) )}^{- 1}\end{matrix} \\ T ( s ) = \frac{y ( s )}{r ( s )} = G ( s ) C ( s ) {( I + G ( s ) C ( s ) )}^{- 1} = I - S ( s )\end{matrix}$$

Assuming that Ws(s) represents a performance weight function, Wr(s) represents a controller output weight function, and Wt(s) represents a robust weight function, to ensure stability of the closed-loop control system, conditions to be satisfied are:

$$\{ \begin{matrix}\begin{matrix}\overline{σ} ( S ( j ω ) ) \leq \overline{σ} [ {Ws}^{- 1} ( j ω ) ] \\ \overline{σ} ( R ( j ω ) ) \leq \overline{σ} [ {Wr}^{- 1} ( j ω ) ]\end{matrix} \\ \overline{σ} ( T ( j ω ) ) \leq \overline{σ} [ {Wt}^{- 1} ( j ω ) ]\end{matrix}$$

An original problem is converted into a standard H∞ control problem, and the original closed-loop control system is augmented to obtain:

$$[ \begin{matrix}\begin{matrix}\begin{matrix}Ws \cdot e \\ Wr \cdot e\end{matrix} \\ Wt \cdot e\end{matrix} \\ e\end{matrix} ] = [ \begin{matrix}Ws & - WsG \\ 0 & Wr \\ 0 & WtG \\ I & - G\end{matrix} ] [ \begin{matrix}r \\ u\end{matrix} ]$$

According to a solution to the standard H∞ control problem, a general solution may be obtained:

$$\{ \begin{matrix}\dot{x} = Ax + Be \\ u = Cx + De\end{matrix}$$

Third, the LADRC controller is designed for the nonlinear model. if bandwidth of an extended state observer (ESO) is wₒ, an influence coefficient of a control quantity on a system state is b₀, a target value estimated by the ESO is z₁, a target-value derivative estimated by the ESO is z₂, and a total system disturbance estimated by the ESO is z₃, because active disturbance rejection control (ADRC) supports decoupling of a multi-variable loop, and the multi-variable loop is directly formed by multiple single-variable control loops connected in parallel, an LADRC closed-loop control system is shown in FIG. 3, and an ESO of the LADRC may be expressed as:

$$\{ \begin{matrix}[ \begin{matrix}\begin{matrix}\dot{{x}_{1}} \\ \dot{{x}_{2}}\end{matrix} \\ \dot{{x}_{3}}\end{matrix} ] = [ \begin{matrix}- 3 {w}_{0} & 1 & 0 \\ - 3 {w}_{o}^{2} & 0 & 1 \\ - 3 {w}_{o}^{3} & 0 & 0\end{matrix} ] [ \begin{matrix}\begin{matrix}{x}_{1} \\ {x}_{2}\end{matrix} \\ {x}_{3}\end{matrix} ] + [ \begin{matrix}0 & 3 {w}_{0} \\ {b}_{0} & 3 {w}_{o}^{2} \\ 0 & {w}_{o}^{3}\end{matrix} ] [ \begin{matrix}u \\ r\end{matrix} ] \\ [ \begin{matrix}\begin{matrix}{z}_{1} \\ {z}_{2}\end{matrix} \\ {z}_{3}\end{matrix} ] = [ \begin{matrix}1 & 0 & 0 \\ 0 & 1 & 0 \\ 0 & 0 & 1\end{matrix} ] [ \begin{matrix}\begin{matrix}{x}_{1} \\ {x}_{2}\end{matrix} \\ {x}_{3}\end{matrix} ] + [ \begin{matrix}0 & 0 \\ 0 & 0 \\ 0 & 0\end{matrix} ] [ \begin{matrix}u \\ r\end{matrix} ]\end{matrix}$$

A control law of the LADRC may be obtained:

$$\{ \begin{matrix}u = \frac{- {z}_{3}}{{b}_{0}} + {u}_{0} \\ {u}_{0} = KP ( r - {z}_{1} ) + KD ( \dot{r} - {z}_{2} )\end{matrix}$$

Step 3: Combine the open-loop controller, the H∞ controller, and the LADRC controller into a switching controller, and design an undisturbed switching method to achieve the four objectives of the present disclosure. The undisturbed switching design method proposed by the present disclosure first finds differentials for outputs of the controllers, then through controller decision, selects a controller to be connected to a closed-loop control circuit, and takes out a differential term of the controller for integral, that is, finding integrals of the controllers, and then using a common integrator to ensure smooth switching, so as to eliminate adverse effects of sudden change and even instability caused by controller switching.

If ù is a derivative of a control quantity u , and switch is a function for selecting a switching controller, indicating that the i-th controller is currently connected to the closed-loop control circuit, an output quantity uₖ of the controller in the k-th running cycle may be expressed as:

$${u}_{k} = {\int }_{0}^{{t}_{k}} switch ( \dot{u} , i ) dt = {\int }_{0}^{{t}_{k - 1}} switch ( \dot{u} , i ) dt + {\int }_{{t}_{k - 1}}^{{t}_{k}} switch ( \dot{u} , i ) dt = {u}_{k - 1} + δ {u}_{k}^{i}$$

The current control quantity uₖ is obtained by adding a control increment Suₖⁱ of the current closed-loop circuit controller to a control quantity uₖ₋₁ at a previous moment, such that smooth controller switching can be implemented without sudden change of control quantities.

Compared with the prior art, the present disclosure has the following beneficial effects:

(1) The present disclosure uses a common integrator for integration after finding differentials of multiple linear controllers, which ensures smooth controller switching without affecting performance of the original controllers, effectively solves the problem of sudden change and even instability caused by the controller switching, and meets the industry's control performance requirements for controller switching.
(2) The undisturbed switching design method proposed by the present disclosure is versatile and is suitable for all linear controllers in a control system, including undisturbed switching between a single-variable controller and a multi-variable controller, and between an open-loop controller and a closed-loop controller.
(3) The undisturbed switching method proposed by the present disclosure has a simple structure, is operable, and can be easily applied to various actual control systems without adjusting parameters of the existing controllers.

### BRIEF DESCRIPTION OF THE DRAWINGS

To make the advantages and implementations of the present disclosure clearer, the present disclosure is described in detail below in conjunction with the accompanying drawings and examples. The accompanying drawings are only used to describe the present disclosure, and are not intended to impose any limitation on the present disclosure.

FIG. 1 is a schematic diagram of a design method for undisturbed switching of linear controllers.

FIG. 2. is a schematic diagram for H∞ control.

FIG. 3 is a schematic diagram for LADRC control.

FIG. 4 is a control effect diagram of a switching controller not including an undisturbed switching design method.

FIG. 5 is a control effect diagram of a switching controller including an undisturbed switching design method.

### DETAILED DESCRIPTION OF THE EMBODIMENTS

The present disclosure is further described below with reference to the accompanying drawings and examples.

The present disclosure provides a design method for undisturbed switching of linear controllers, and treats an open-loop controller as a linear controller, to solve the problem of sudden system change or even instability caused by linear controller switching in practical projects.

A design method for undisturbed switching of linear controllers includes the following steps.

Step 1: Directly establish a numerical simulation program of a control system without considering impact of controller switching. FIG. 1 shows a control framework of the control system, in which a plant is a general nonlinear model. In this embodiment, the nonlinear model is specifically a dual-rotor turbofan engine, which is expressed as:

$$\{ \begin{matrix}\dot{x} = f ( x , u ) \\ y = g ( x , u )\end{matrix}$$

where f is a nonlinear function of system state; g is a nonlinear function of system output; u is a control quantity output by a switching controller, which may be expressed as u=[WF M,A8]^{T}; and y is an output quantity of the engine, which may be expressed as y=[N₂,π_{T}]^{T}.

Step 2: Without considering impact of controller switching, directly design controllers such that performance of the closed-loop control system meets an expected design requirement. The undisturbed switching design method proposed in the present disclosure is for all linear controllers and open-loop controllers, such as PID, LQG, LADRC, H∞, MRAC, and open-loop controllers. The controller in the present disclosure is specifically a switching controller including an open-loop controller, an H∞ controller, and an LADRC controller.

First, in terms of the open-loop controller, the nonlinear model is designed as follows: an open-loop control law is abstracted as an interpolation function interp according to an interpolation table [r_{Table};value_{Table}], and a reference input is set to r, to obtain:

u=interp(r,[r_{Table};value_{Table}])

Based on engineering experience, an open-loop control law may be obtained:

$$[ \begin{matrix}WFM \\ A 8\end{matrix} ] = interp ( r , [ \begin{matrix}[ \begin{matrix}15 , 20 , 25 , 30 , 35 , 40 , 45 , 50 , 55 \\ 15 , 20 , 25 , 30 , 35 , 40 , 45 , 50 , 55\end{matrix} ] , \\ [ \begin{matrix}5000 , 6000 , 10000 , 15000 , 18000 , 20000 , 22000 , 25000 , 28000 \\ 500 , 480 , 450 , 440 , 400 , 380 , 350 , 310 , 300\end{matrix} ]\end{matrix} ] )$$

Second, in terms of the H∞ controller, the nonlinear model is designed as follows: and the nonlinear model is linearized to obtain a linear system:

$$\{ \begin{matrix}\dot{x} = Ax + Bu \\ y = Cx + Du\end{matrix}$$

The dual-rotor turbofan engine model is linearized, and according to a small deviation model method, a linear model is obtained through system identification at equilibrium points of idle and above states, which is expressed as:

$$\{ \begin{matrix}[ \begin{matrix}{\dot{x}}_{1} \\ {\dot{x}}_{2}\end{matrix} ] = [ \begin{matrix}- 4.348 & 7.408 \\ 3.6964 & - 44.6039\end{matrix} ] [ \begin{matrix}{x}_{1} \\ {x}_{2}\end{matrix} ] + [ \begin{matrix}0.0131 & - 0.0139 \\ 0.0202 & 0.0888\end{matrix} ] [ \begin{matrix}WFM \\ A 8\end{matrix} ] \\ [ \begin{matrix}{N}_{2} \\ {π}_{T}\end{matrix} ] = [ \begin{matrix}1 & 0 \\ 0 & 1\end{matrix} ] [ \begin{matrix}{x}_{1} \\ {x}_{2}\end{matrix} ] + [ \begin{matrix}0 & 0 \\ 0 & 0\end{matrix} ] [ \begin{matrix}WFM \\ A 8\end{matrix} ]\end{matrix}$$

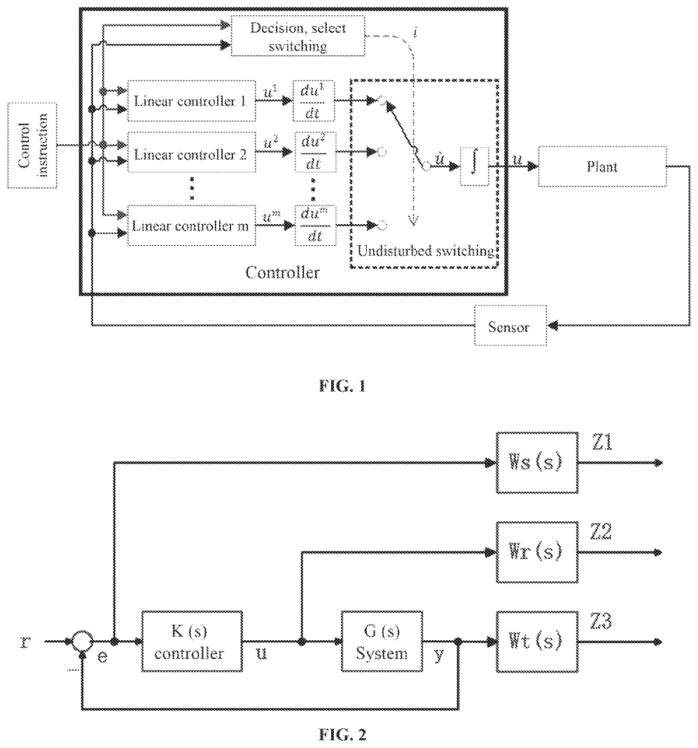

FIG. 2 is a schematic diagram of a closed-loop control system based on H∞. If r, e, u and y represent a reference input, a tracking error, a control input, and a system output, respectively, C(s) represents an H∞ controller, and G(s) represents a controlled-object model, closed-loop transfer functions from r to e, u, and y separately may be obtained:

$$\{ \begin{matrix}\begin{matrix}S ( s ) = \frac{e ( s )}{r ( s )} = {( I + G ( s ) C ( s ) )}^{- 1} \\ R ( s ) = \frac{u ( s )}{r ( s )} = C ( s ) S ( s ) = C ( s ) {( I + G ( s ) C ( s ) )}^{- 1}\end{matrix} \\ T ( s ) = \frac{y ( s )}{r ( s )} = G ( s ) C ( s ) {( I + G ( s ) C ( s ) )}^{- 1} = I - S ( s )\end{matrix}$$

Assuming that Ws(s) represents a performance weight function, Wr(s) represents a controller output weight function, and Wt(s) represents a robust weight function, to ensure stability of the closed-loop control system, conditions to be satisfied are:

$$\{ \begin{matrix}\begin{matrix}\overline{σ} ( S ( j ω ) ) \leq \overline{σ} [ {Ws}^{- 1} ( j ω ) ] \\ \overline{σ} ( R ( j ω ) ) \leq \overline{σ} [ {Wr}^{- 1} ( j ω ) ]\end{matrix} \\ \overline{σ} ( T ( j ω ) ) \leq \overline{σ} [ {Wt}^{- 1} ( j ω ) ]\end{matrix}$$

An original problem is converted into a standard H∞ control problem, and the original closed-loop control system is augmented to obtain:

$$[ \begin{matrix}\begin{matrix}\begin{matrix}Ws \cdot e \\ Wr \cdot e\end{matrix} \\ Wt \cdot e\end{matrix} \\ e\end{matrix} ] = [ \begin{matrix}Ws & - WsG \\ 0 & Wr \\ 0 & WtG \\ I & - G\end{matrix} ] [ \begin{matrix}r \\ u\end{matrix} ]$$

According to a solution to the standard H∞ control problem, a general solution may be obtained:

$$\{ \begin{matrix}\dot{x} = Ax + Be \\ u = Cx + De\end{matrix} ,$$

According to a DGKF solution to the standard H∞ control problem, a feasible solution may be obtained:

$$\{ \begin{matrix}\dot{x} = [ \begin{matrix}- 1 e - 5 & 0 & 0 & 0 & 0 & 0 \\ 0 & - 1 e - 5 & 0 & 0 & 0 & 0 \\ 0 & 0 & - 0.8882 & 0 & 0 & 0 \\ 0 & 0 & 0 & - 0.9288 & 0 & 0 \\ 0 & 0 & 0 & 0 & - 9.189 & 0 \\ 0 & 0 & 0 & 0 & 0 & - 63.43\end{matrix} ] x + \\ [ \begin{matrix}12.05 & 2.802 \\ - 3.693 & 16.49 \\ 3.988 & 1.233 \\ - 1.096 & 4.362 \\ - 15.48 & - 2.872 \\ - 0.63 & - 10.24\end{matrix} ] [ \begin{matrix}{N}_{{2}_{err}} \\ {N}_{{T}_{err}}\end{matrix} ] \\ [ \begin{matrix}WFM \\ A 8\end{matrix} ] = [ \begin{matrix}12.28 & - 2.367 & - 3.376 & 0.762 & - 13 & - 1.825 \\ 1.534 & 16.7 & - 0.7573 & - 4.406 & 1.34 & - 9.903\end{matrix} ] x + \\ [ \begin{matrix}0 & 0 \\ 0 & 0\end{matrix} ] [ \begin{matrix}{N}_{{2}_{err}} \\ {N}_{{T}_{err}}\end{matrix} ]\end{matrix}$$

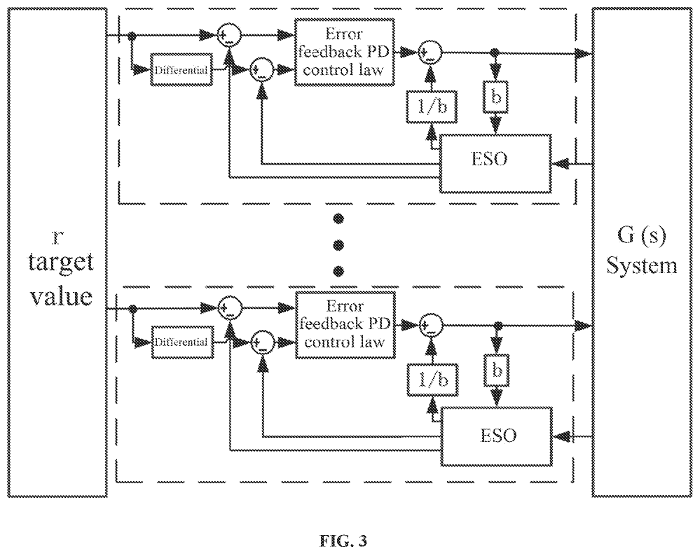

Third, the LADRC controller is designed for the nonlinear model. If bandwidth of an ESO is wₒ, an influence coefficient of a control quantity on a system state is b₀, a target value estimated by the ESO is z₁, a target-value derivative estimated by the ESO is z₂, and a total system disturbance estimated by the ESO is z₃, because ADRC supports decoupling of a multi-variable loop and the multi-variable loop is directly formed by multiple single-variable control loops connected in parallel, an LADRC closed-loop control system is shown in FIG. 3, and an ESO of the LADRC may be expressed as:

$$\{ \begin{matrix}[ \begin{matrix}{\dot{x}}_{1} \\ {\dot{x}}_{2} \\ {\dot{x}}_{3}\end{matrix} ] = [ \begin{matrix}- 3 {w}_{0} & 1 & 0 \\ - 3 {w}_{o}^{2} & 0 & 1 \\ - {w}_{o}^{3} & 0 & 0\end{matrix} ] [ \begin{matrix}{x}_{1} \\ {x}_{2} \\ {x}_{3}\end{matrix} ] + [ \begin{matrix}0 & 2 {w}_{0} \\ {b}_{0} & 3 {w}_{o}^{3} \\ 0 & {w}_{o}^{3}\end{matrix} ] [ \begin{matrix}u \\ r\end{matrix} ] \\ [ \begin{matrix}{z}_{1} \\ {z}_{2} \\ {z}_{3}\end{matrix} ] = [ \begin{matrix}1 & 0 & 0 \\ 0 & 1 & 0 \\ 0 & 0 & 1\end{matrix} ] [ \begin{matrix}{x}_{1} \\ {x}_{2} \\ {x}_{3}\end{matrix} ] + [ \begin{matrix}0 & 0 \\ 0 & 0 \\ 0 & 0\end{matrix} ] [ \begin{matrix}u \\ r\end{matrix} ]\end{matrix}$$

A control law of the LADRC may be obtained:

$$\{ \begin{matrix}u = \frac{- {z}_{3}}{{b}_{0}} + {u}_{0} \\ {u}_{0} = KP ( r - {z}_{1} ) + KD ( \dot{r} - {z}_{1} )\end{matrix}$$

After repeated parameter adjustment, specific parameters of LADRC may be obtained:

$$\{ \begin{matrix}{KP}_{WFM} = 100 , {KD}_{WFM} = 2 , {w}_{{0}_{WFM}} = 15 , {b}_{{0}_{WFM}} = 2 \\ {KP}_{A 8} = 100 , {KD}_{A 8} = 2 , {w}_{{0}_{A 8}} = 15 , {b}_{{0}_{A 8}} = 15 , {b}_{{0}_{A 8}} = 1\end{matrix}$$

Step 3: Combine the open-loop controller, the H∞ controller, and the LADRC controller into a switching controller, and design an undisturbed switching method to achieve the four objectives of the present disclosure. The undisturbed switching design method proposed by the present disclosure first finds differentials for outputs of the controllers, then through controller decision, selects a controller to be connected to a closed-loop control circuit, and takes out a differential term of the controller for integration, that is, finding integrals of the controllers, and then using a common integrator to ensure smooth switching, so as to eliminate adverse effects of sudden change and even instability caused by controller switching.

If ù is a derivative of a control quantity u, and switch is a function for selecting a switching controller, indicating that the i-th controller is currently connected to the closed-loop control circuit, an output quantity uₖ of the controller in the k-th running cycle may be expressed as:

$${u}_{k} = {\int }_{0}^{{t}_{k}} switch ( \dot{u} , i ) dt = {\int }_{0}^{{t}_{k - 1}} switch ( \dot{u} , i ) dt + {\int }_{{t}_{k - 1}}^{{t}_{k}} switch ( \dot{u} , i ) dt = {u}_{k - 1} + δ {u}_{k}^{i}$$

The current control quantity uₖ is obtained by adding a control increment Suₖⁱ of the current closed-loop circuit controller to a control quantity uₖ₋₁ at a previous moment, such that smooth controller switching can be implemented without sudden change of control quantities.

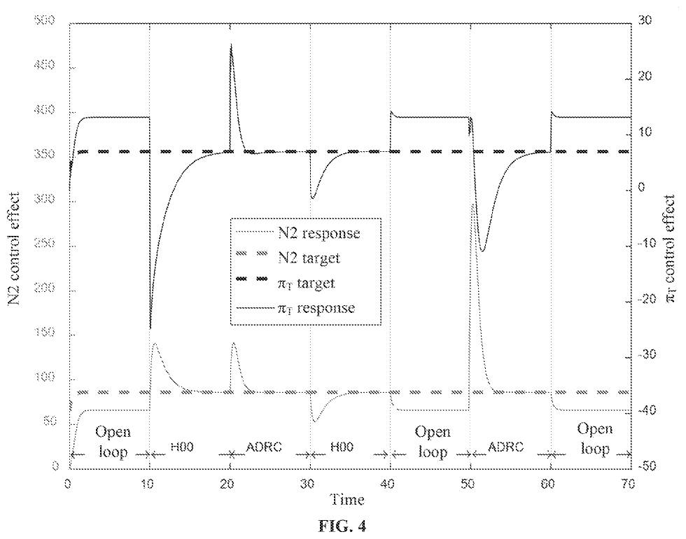

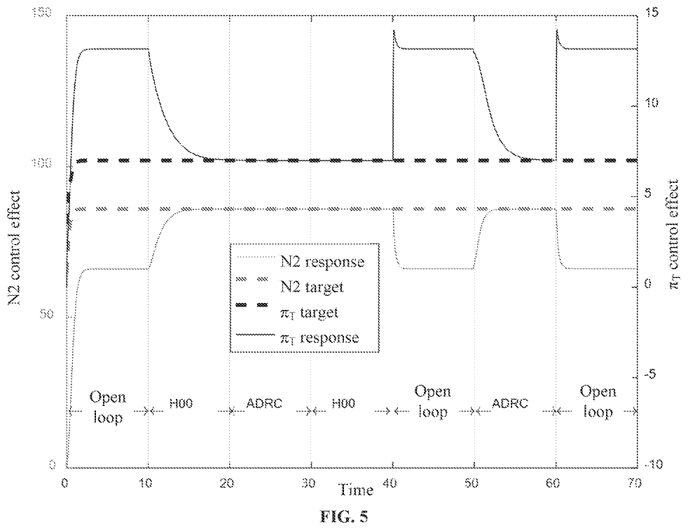

After the above three steps, a switching controller composed of the open-loop controller, the H∞ controller, and the LADRC controller is obtained. FIG. 4 shows a control effect of the switching controller not including the undisturbed switching design method. FIG. 5 shows a control effect of the switching controller including the undisturbed switching design method. It can be seen that the design method for undisturbed switching of linear controllers proposed by the present disclosure has significant improvements, and its beneficial effects are as follows:

(1) The present disclosure uses a common integrator for integration after finding differentials of multiple linear controllers, which ensures smooth controller switching without affecting performance of an original controller, effectively solves the problem of sudden change or even unstable control caused by the controller switching, and meets the industry's control performance requirements for controller switching.
(2) The undisturbed switching design method proposed by the present disclosure is versatile and is suitable for all linear controllers in a control system, including undisturbed switching between a single-variable controller and a multi-variable controller, and between an open-loop controller and a closed-loop controller.
(3) The undisturbed switching method proposed by the present disclosure has a simple structure, is operable, and can be easily applied to various actual control systems without adjusting parameters of the existing controllers.

The examples of the present disclosure are described above in detail, which are merely preferred examples of the present disclosure and cannot be construed as limiting the scope of implementation of the present disclosure. The implementations of the steps may be quantity, and all equivalent changes and improvements made according to the scope of the present disclosure should still fall within the scope of this patent.

1. A design method for undisturbed switching of linear controllers, comprising the following steps:
step 1: establishing a numerical simulation program of a control system;
step 2: configuring controllers to allow performance of a closed-loop control system to meet an expected design requirement, wherein the controllers comprise linear controllers and an open-loop controller; and
step 3: combining the open-loop controller and the linear controllers into a switching controller by: differentiating outputs of the linear controllers, then based on a decision of the switching controller, selecting one of the linear controllers to be connected to form a closed-loop control circuit, and taking out a differential term of the linear controllers for integration; wherein taking out the differential term of the linear controllers for integration comprises differentiating the linear controllers, and then using a common integrator to ensure smooth switching, resulting in eliminating adverse effects of sudden change or instability caused by controller switching.

2. The design method for undisturbed switching of linear controllers according to claim 1, wherein in step 1, a plant controlled by the switching controller is a general nonlinear model, which is expressed as:
$$\{ \begin{matrix}\dot{x} = f ( x , u ) \\ y = g ( x , u )\end{matrix} ,$$
wherein f is a nonlinear function of a system state; g is a nonlinear function of a system output; y is an output quantity of the plant; and u is a control quantity output by the switching controller.

3. The design method for undisturbed switching of linear controllers according to claim 1, wherein in step 2, the switching controller comprising the open-loop controller, an H∞ controller, and a linear active disturbance rejection control (LADRC) controller; and the design method further comprises the following steps:
first, the open-loop controller is configured based on a nonlinear mode, wherein: an open-loop control law is abstracted as an interpolation function interp according to an interpolation table [r_{Table};value_{Table}], and a reference input is set to r, to obtain:
u=interp(r,[r_{Table};value_{Table}]),
second, the H∞ controller is configured based on the nonlinear model; and the nonlinear model is linearized to obtain a linear system:
$$\{ \begin{matrix}\dot{x} = Ax + Bu \\ u = Cx + Du\end{matrix} ,$$
wherein r, e, u, and y represent a reference input, a tracking error, a control input, and a system output, respectively, C(s) represents the H∞ controller, and G(s) represents a controlled-object model, wherein closed-loop transfer functions for r to e, u, and y separately are:
$$\{ \begin{matrix}S ( s ) = \frac{e ( s )}{r ( s )} = {( I + G ( s ) C ( s ) )}^{- 1} \\ R ( s ) = \frac{u ( s )}{r ( s )} = C ( s ) S ( s ) = C ( s ) {( I + G ( s ) C ( s ) )}^{- 1} \\ T ( s ) = \frac{y ( s )}{r ( s )} = G ( s ) C ( s ) {( I + G ( s ) C ( s ) )}^{- 1} = I - S ( s )\end{matrix} ,$$
wherein that Ws(s) represents a performance weight function, Wr(s) represents a controller output weight function, and Wt(s) represents a robust weight function to ensure stability of the closed-loop control system, wherein conditions to be satisfied are:
$$\{ \begin{matrix}\overline{σ} ( S ( j ω ) ) \leq \overline{σ} [ {Ws}^{- 1} ( j ω ) ] \\ \overline{σ} ( R ( j ω ) ) \leq \overline{σ} [ {Wr}^{- 1} ( j ω ) ] \\ \overline{σ} ( T ( j ω ) ) \leq \overline{σ} [ {Wt}^{- 1} ( j ω ) ]\end{matrix} ,$$
an original problem is converted into a standard H∞ control problem, and an original closed-loop control system is augmented to obtain:
$$[ \begin{matrix}Ws \cdot e \\ Wr \cdot e \\ Wt \cdot e \\ e\end{matrix} ] = [ \begin{matrix}Ws & - WsG \\ 0 & Wr \\ 0 & WtG \\ I & - G\end{matrix} ] [ \begin{matrix}r \\ u\end{matrix} ] ,$$
and according to a solution to the standard H control problem, a general solution is obtained:
$$\{ \begin{matrix}\dot{x} = Ax + Be \\ u = Cx + De\end{matrix} ,$$
third, the LADRC controller is configured based on the nonlinear model; wherein a bandwidth of an extended state observer (ESO) is wₒ, an influence coefficient of a control quantity on a system state is b₀, a target value estimated by the ESO is z₁, a target-value derivative estimated by the ESO is z₂, and a total system disturbance estimated by the ESO is z₃, an active disturbance rejection control (ADRC) supports decoupling of a multi-variable loop and the multi-variable loop is directly formed by multiple single-variable control loops connected in parallel, and an ESO of the LADRC controller is expressed as:
$$\{ \begin{matrix}[ \begin{matrix}{\dot{x}}_{1} \\ {\dot{x}}_{2} \\ {\dot{x}}_{3}\end{matrix} ] = [ \begin{matrix}- 3 {w}_{0} & 1 & 0 \\ - 3 {w}_{o}^{2} & 0 & 1 \\ - {w}_{o}^{3} & 0 & 0\end{matrix} ] [ \begin{matrix}{x}_{1} \\ {x}_{2} \\ {x}_{3}\end{matrix} ] + [ \begin{matrix}0 & 3 {w}_{0} \\ {b}_{0} & 3 {w}_{o}^{3} \\ 0 & {w}_{o}^{3}\end{matrix} ] [ \begin{matrix}u \\ r\end{matrix} ] \\ [ \begin{matrix}{z}_{1} \\ {z}_{2} \\ {z}_{3}\end{matrix} ] = [ \begin{matrix}1 & 0 & 0 \\ 0 & 1 & 0 \\ 0 & 0 & 1\end{matrix} ] [ \begin{matrix}{x}_{1} \\ {x}_{2} \\ {x}_{3}\end{matrix} ] + [ \begin{matrix}0 & 0 \\ 0 & 0 \\ 0 & 0\end{matrix} ] [ \begin{matrix}u \\ r\end{matrix} ]\end{matrix} ,$$
and a control law of the LADRC controller is obtained:
$$\{ \begin{matrix}u = \frac{- {z}_{3}}{{b}_{0}} + {u}_{0} \\ {u}_{0} = KP ( r - {z}_{1} ) + KD ( \dot{r} - {z}_{2} )\end{matrix} .$$

4. The design method for undisturbed switching of linear controllers according to claim 1, wherein in step 3, when ù is a derivative of a control quantity u, and switch is a function for selecting the switching controller, indicating that an i-th controller is currently connected to the closed-loop control circuit, an output quantity uₖ of the controller in a k-th running cycle is expressed as:
$$\begin{matrix}{u}_{k} = {\int }_{0}^{{t}_{k}} switch ( \dot{u} , i ) dt = {\int }_{0}^{{t}_{k - 1}} switch ( \dot{u} , i ) dt + {\int }_{{t}_{k - 1}}^{{t}_{k}} switch ( \dot{u} , i ) dt = \\ {u}_{k - 1} + δ {u}_{k}^{i}\end{matrix} ,$$
wherein a current control quantity uₖ is obtained by adding a control increment Suₖⁱ of a current closed-loop circuit controller to a control quantity uₖ₋₁ at a previous moment, resulting in enabling a smooth controller switching without sudden change of control quantities.
